(19) United States
(12) Patent Application Publication
(10) Pub. No.: US 2016/0159213 A1
(43) Pub. Date: Jun. 9, 2016

(54) HYBRID ELECTRIC GROUND MOBILITY SYSTEM

(71) Applicant: GM GLOBAL TECHNOLOGY OPERATIONS LLC, Detroit, MI (US)

(72) Inventor: Alan G. Holmes, Clarkston, MI (US)

(73) Assignee: GM GLOBAL TECHNOLOGY OPERATIONS LLC, Detroit, MI (US)

(21) Appl. No.: 14/561,907

(22) Filed: Dec. 5, 2014

(51) Int. Cl. B60K 7/00; B60K 6/22; B60B 1/00

(52) U.S. Cl. CPC B60K 7/0007; B60B 1/00; B60K 6/22; B60B 2900/90; Y10S 903/904

(57) ABSTRACT

A wheel assembly for a vehicle includes a hub portion supporting a plurality of controllable variable length radially-oriented spoke elements supporting a conformable rim assembly supporting a tire element. The hub portion is concentric to an axis of rotation and includes a support structure. The controllable variable length radially-oriented spoke elements are perpendicular to the axis of rotation and each includes a first end mechanically coupled to the support structure of the hub portion, a length-varying actuator individually controllable to a selected length and a second end coupled to an inner periphery of the conformable rim assembly. The conformable rim assembly includes a plurality of segmented sections.

### TECHNICAL FIELD

This disclosure relates to vehicle propulsion systems.

### BACKGROUND

Known vehicle powertrain systems generate tractive torque for vehicle propulsion by converting combustible fuel and/or stored electric power to rotational torque that is transferred to vehicle drive wheels.

### SUMMARY

A wheel assembly for a vehicle includes a hub portion supporting a plurality of controllable variable length radially-oriented spoke elements supporting a conformable rim assembly supporting a tire element. The hub portion is concentric to an axis of rotation and includes a support structure. The controllable variable length radially-oriented spoke elements are perpendicular to the axis of rotation and each includes a first end mechanically coupled to the support structure of the hub portion, a length-varying actuator individually controllable to a selected length and a second end coupled to an inner periphery of the conformable rim assembly. The conformable rim assembly includes a plurality of segmented sections.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIG. 1 schematically illustrates a front partial cut-away view of a vehicle including a propulsion system employing a power-split powertrain system including first and second electro-mechanical wheels, in accordance with the disclosure;

FIG. 2 schematically shows a partial cutaway side view of an embodiment of an electro-mechanical wheel assembled onto a vehicle axle, including an array of radially-oriented variable length linear actuators assembled on a wheel hub and supporting an annular conformable rim assembly supporting a tire element, in accordance with the disclosure;

FIG. 3 is an isometric view of an embodiment of a two-wheeled vehicle employing an embodiment of the electro-mechanical wheels, in accordance with the disclosure; and

FIGS. 4-1 and 4-2 schematically illustrate an embodiment of a two-wheeled vehicle employing an embodiment of the electro-mechanical wheels in accordance with the disclosure.

### DETAILED DESCRIPTION

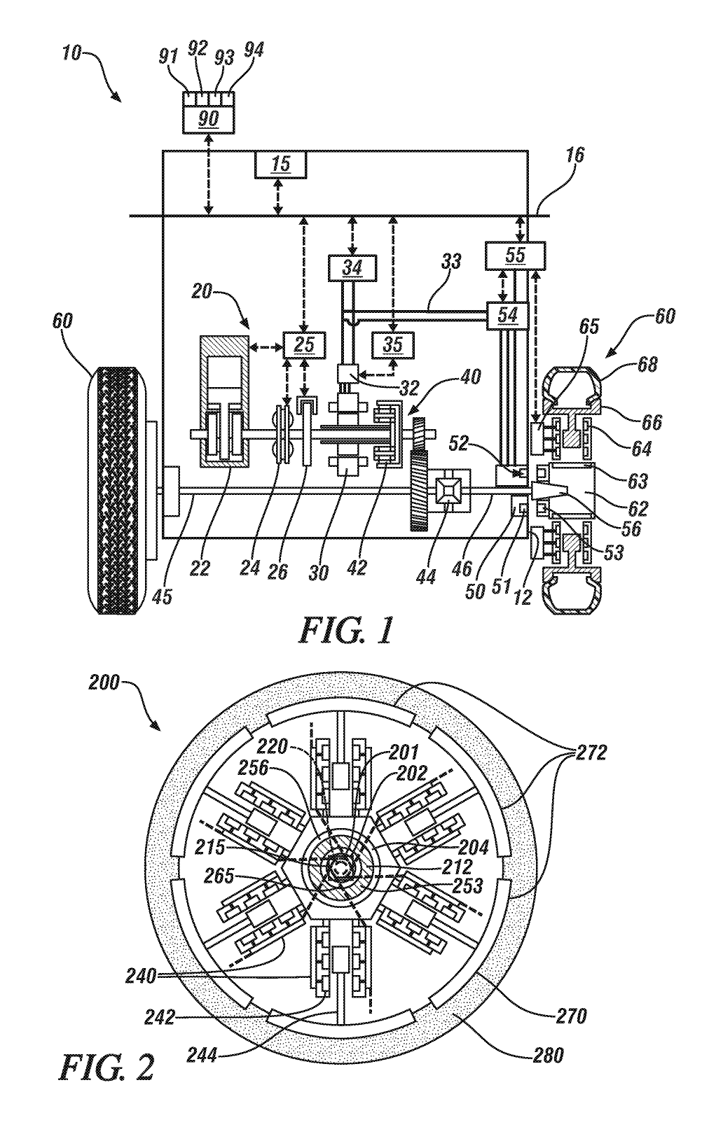

Referring now to the drawings, wherein the depictions are for the purpose of illustrating certain exemplary embodiments only and not for the purpose of limiting the same, FIG. 1 schematically illustrates a front partial cut-away view of a vehicle 10 including a propulsion system employing a power-split powertrain system 20. The power-split powertrain system 20 includes an internal combustion engine (engine) 22, a motor/generator 30 and a gear train 40 coupled to first and second electro-mechanical wheels 60, wherein the electro-mechanical wheels 60 generate vehicle propulsion and forward motion without imparting torque to the powertrain system 20.

The engine 22 may be any suitable device that combusts fuel to generate torque, and is preferably configured to execute autostart and autostop operations. As shown the engine 22 couples to an isolator device 24 that reduces torsional engine vibration transmitted to other powertrain elements. The isolator 24 couples through a brake element 26 that couples to a node of a planetary gear set 42 of the gear train 40 via a shaft member or other suitable torque coupling device. The engine 22 and brake 26 are operationally controlled by an engine controller 25. The motor/generator 30 rotatably couples to another node of the planetary gear set 42. The motor/generator 30 can be any suitable non-combustion torque machine, and as shown is a multi-phase electrical motor including a rotor and stator that electrically connects to an inverter 32. A high-voltage battery 34 electrically connects via a high-voltage bus 33 to the inverter 32 that electrically powers the motor/generator 30 in response to control signals from an inverter controller 35. The planetary gear set 42 includes another node that rotatably couples through the gear train 40 to a differential gear set 44 that couples to a pair of axles 45, 46 to transfer torque to the wheels 60. The vehicle axles 45, 46 are oriented on a single, common axis of rotation of the wheels 60. The planetary gear set 42 can be any suitable gear set that multiplies and transfers torque inputs from torque generative devices such as the engine 22 and motor/generator 30. The powertrain configuration of the engine 22, motor/generator 30 and gear train 40 is illustrative. Other powertrain configurations that deliver tractive torque to the vehicle axles 45, 46 may be employed within the scope of the disclosure. Those skilled in the art appreciate that other unillustrated powertrain and vehicle components may be employed.

The vehicle 10 includes a plurality of user interface devices through which an operator commands operation of the vehicle. This is depicted as user interface controller 90 having operator input elements including an accelerator pedal 91, a brake pedal 92, a steering wheel 93 and an ignition switch 94. The depiction of the user interface devices is illustrative. Those skilled in the art appreciate that user interface devices may be in a variety of suitable forms. The vehicle includes a controller 15 that provides overarching control of the inverter controller 35, the engine controller 25, an electro-mechanical wheel controller 55, the user interface controller 90 and other vehicle controllers.

The terms controller, control module, module, control, control unit, processor and similar terms refer to any one or various combinations of Application Specific Integrated Circuit(s) (ASIC), electronic circuit(s), central processing unit(s), e.g., microprocessor(s) and associated non-transitory memory component in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning and buffer circuitry and other components that can be accessed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms and similar terms mean any controller-executable instruction sets including calibrations and look-up tables. Each controller executes control routine(s) to provide desired functions, including monitoring inputs from sensing devices and other networked controllers and executing control and diagnostic routines to control operation of actuators. Routines may be executed at regular intervals, for example each 100 microseconds. Alternatively, routines may be executed in response to occurrence of a triggering event. Communications between controllers and between controllers, actuators and/or sensors may be accomplished using a suitable communications link 16, e.g., a direct wired link, a networked communications bus link, or a wireless link. Communications includes exchanging data signals in any suitable form, including, for example, electrical signals via a conductive medium, electromagnetic signals via air, optical signals via optical waveguides, and the like.

The vehicle 10 includes a structural element 12 on which a vehicle hub 50 and accompanying bearing assembly mounts. The vehicle axle 46 passes through an opening in the vehicle hub 50 and couples to a spindle 56. The vehicle axle 46 rotates within the vehicle hub 50 and the bearing assembly. The structural element 12 and vehicle hub 50 may include other vehicle elements such as suspension components, braking components and the like, which are not shown.

The vehicle hub 50 provides a mounting platform for a stator 51 of a rotary transformer 52 and the spindle 56 provides a mounting platform for a rotor 53 of the rotary transformer 52. The stator 51 electrically connects to an inverter 54 that electrically connects to the battery 34 via high-voltage bus 33. Inverter 54 is operatively controlled by the electro-mechanical wheel controller 55. Alternatively, a second battery may be employed to supply electric power to the inverter 54. The rotary transformer 52 is a ring transformer or another suitable device that transfers electric power in the form of an alternating current between the stator 51 and the rotor 53 with an intervening air core.

One of the electro-mechanical wheels 60 is shown in detail, and includes a wheel hub 62 that fixedly mounts onto the spindle 56 and rotates therewith. The wheel hub 62 includes a support structure 63 that supports multiple controllable variable length linear actuators (linear actuators) 64 acting as spoke elements that support a conformable rim assembly 66 that supports a tire element 68. The wheel hub 62 is concentric to an axis of rotation defined by the axle 46. The linear actuators 64 are perpendicular to the axis of rotation in one embodiment, and each includes a first end mechanically coupled to the support structure 63 of the wheel hub 62 and a second end coupled to an inner periphery of the conformable rim assembly 66. Each of the linear actuators 64 is a length-varying actuator that is individually controllable to a selected length. The conformable rim assembly 66 includes a plurality of segmented sections. A power control and distribution system 65 electrically connects to the rotor 53 of the rotary transformer 52 and communicates with the electro-mechanical wheel controller 55. In this manner, the rotary transformer 52 electrically operatively couples to the linear actuators 64 via the power control and distribution system 65 to provide electric power for extension and retraction thereof to effect the variation in length.

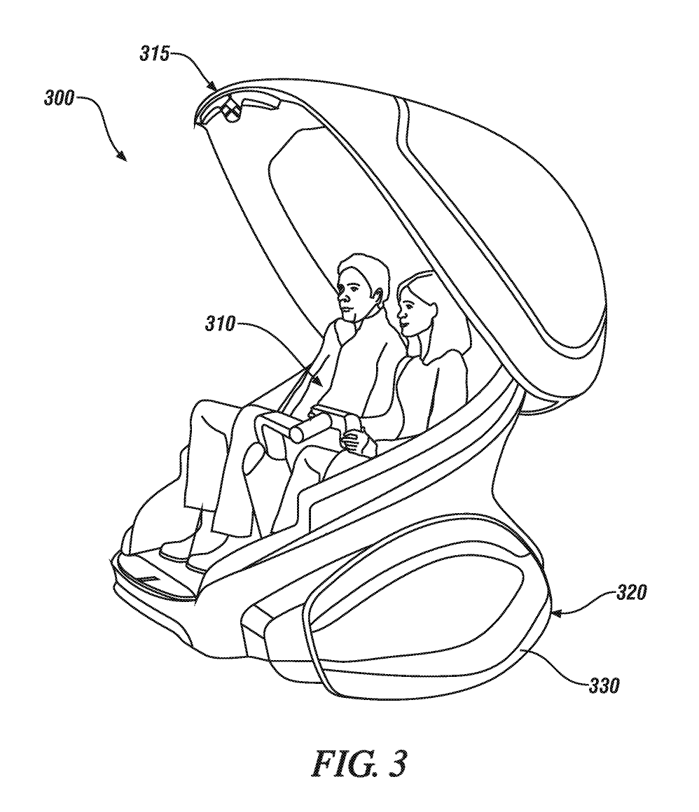

FIG. 2 schematically shows a partial cutaway side view of an embodiment of the electro-mechanical wheel assembly 200 assembled onto a vehicle axle 201, including an array of radially-oriented variable length linear actuators (linear actuators) 240 assembled on the wheel hub 220 acting as spoke elements that support an annular conformable rim assembly 270 supporting a tire element 280 that contacts a road surface. The electro-mechanical wheel assembly 200 is shown having six linear actuators 240 arranged at 60° intervals around an outer periphery of the wheel hub 220. Other configurations may employ other quantities of the linear actuators 240 without limitation, including, e.g., five linear actuators arranged at 72° intervals around an outer periphery of the wheel hub or eight linear actuators arranged at 45° intervals around an outer periphery of the wheel hub.

The vehicle hub 202 and electrical stator 212 provide mounting for the axle 201 that couples to the spindle 204 on which the wheel hub 220 and electrical rotor 253 are mounted. The electrical rotor 253 corresponds to the rotor 53 of rotary transformer 52 (shown in FIG. 1) and electrically connects to each of the linear actuators 240 to transfer electrical power thereto, preferably via a power control and distribution system 265. In an embodiment, the power control and distribution system 265 is shown as an array of elements, each of which is attached to one of the linear actuators 240, electrically connected with the rotor 253 and in signal communication with the electro-mechanical wheel controller 55 (shown in FIG. 1) such as by using wireless communications via an antenna 256. In another embodiment, the power control and distribution system 265 may be in signal communication with the electro-mechanical wheel controller 55 using the rotary transformer 52 and inverter 54 (shown in FIG. 1). In one embodiment, each of the linear actuators 240 signally connects to a communications element 215 that mounts to the wheel hub 220, with the communications element 215 signally connected to the electro-mechanical wheel controller 55 (shown with reference to FIG. 1). The electro-mechanical wheel controller 55 commands extension and retraction of individual ones of the linear actuators 240.

The linear actuators 240 are perpendicular to an axis of rotation of the axle 201 in the embodiment shown. Each linear actuator 240 includes a stator portion 242 and a moveable plunger 244. Each of the linear actuators 240 is individually controllable to achieve a selectable predetermined length. A distal end of the plunger 244 couples to an inner periphery of the conformable rim assembly 270. The linear actuators 240 can be any suitable form of electro-mechanical device that converts electrical power to linear translation to extend or retract the plunger 244, and thus extend or retract a corresponding portion of the conformable rim assembly 270. In one embodiment, the linear actuator 240 includes a 40 mm integrated air-strut and linear-motor actuators and an outside diameter of the rim portion of 900 mm (35 inch) having a width of 50 mm.

The conformable rim assembly 270 is a multi-piece annular device that includes suitable elements to structurally support to the tire assembly 280. As shown, the conformable rim assembly 270 includes six detached arc sections 272 that attach to corresponding ones of the six linear actuators 240. Alternatively, the six arc sections 272 may be flexibly attached one to another via a hinge or other suitable device at the interfaces therebetween.

The tire assembly 280 is a device that is structurally supported by and conforms to the conformable rim assembly 270, and can be any suitable device that provides traction between the wheel assembly 200 and a ground surface and also preferably provides some magnitude of elastic deformation between the wheel assembly 200 and the ground surface to absorb shocks. The tire assembly 280 conforms to the conformable rim assembly 270 when selected ones of the linear actuators 240 are extended or retracted. In one embodiment, the tire assembly 280 is a unitary annular inflatable pneumatic device. In one embodiment, the tire assembly 280 is a unitary non-inflatable pneumatic device. In one embodiment, the tire assembly 280 is a unitary hydraulically-filled device. In one embodiment, the tire assembly 280 is a track device. In one embodiment, the tire assembly 280 is a segmented device having a plurality of individual segments attached to corresponding segments of the conformable rim assembly 270, with each of the individual segments including a stand-alone pneumatic, hydraulic or solid device.

One operating principle associated with the electro-mechanical wheel assembly described herein is that it permits an active manipulation of position of the wheel's center by extension or retraction of individual ones of the linear actuators, including active manipulation of position of the wheel's center relative to a center of gravity of the vehicle. When the wheel's center is not concentric with the vehicle center of gravity, a net moment is generated by action of gravity on the wheel and the vehicle.

Positioning the wheel's center in an eccentric position relative to the vehicle center can generate forward or reverse motion of the vehicle or assist motion generated in part by torque applied to the axle by a conventional rotary electric motor/generator, an engine or a combination thereof. When torque is applied to the axle by a combination of an engine and an electric motor/generator coupled with a planetary gear set, a power-split propulsion system can be formed that includes the electro-mechanical wheel acting as one of the motor/generators. Specifically, the electro-mechanical wheel may be used as an output-coupled motor/generator in an input-power-split hybrid propulsion system. The electro-mechanical wheel assembly 200 also is able to apply wheel eccentricity to effect braking when the vehicle is in motion and to effect vehicle balancing when the vehicle is at a stopped position.

FIG. 3 is an isometric view of an embodiment of a two-wheeled vehicle 300 that may employ an embodiment of the electro-mechanical wheel assembly 330. As shown, the vehicle 300 includes a passenger compartment 310 enclosed by a canopy 315, shown in an open position. A wheel cover 320 covers one of the wheel assemblies 330, which may be embodiments of the electro-mechanical wheel assemblies 200 described with reference to FIG. 2. The electro-mechanical wheel assemblies 200 can be configured and controlled to provide propulsion, steering, and suspension for the vehicle 300.

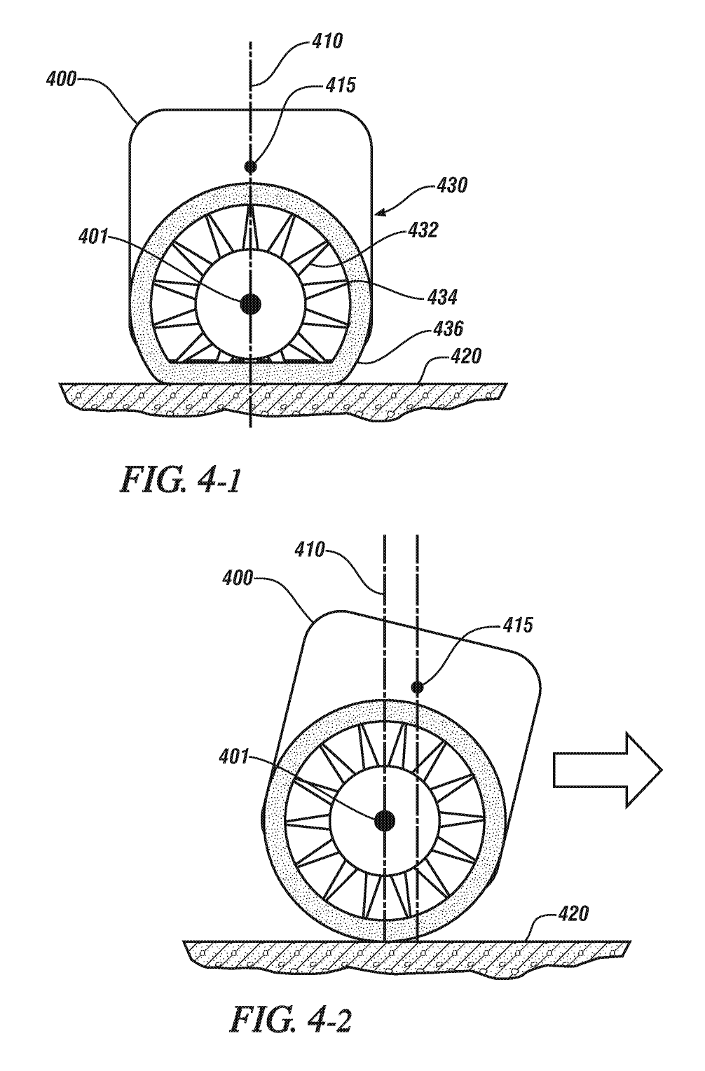

FIGS. 4-1 and 4-2 schematically illustrate an embodiment of a two-wheeled vehicle 400 employing an embodiment of the electro-mechanical wheel assembly 430 that rotates about a single, common axis of rotation defined by an axle 401. One of the electro-mechanical wheel assemblies 430 is shown and includes twelve linear actuators 432. A center of gravity point 415 for the vehicle 400 is also shown. FIG. 4-1 illustrates the embodiment of the two-wheeled vehicle 400 in a stationary state employing an embodiment of the electro-mechanical wheel assembly 430. As shown, nine of the linear actuators 432 are in a fully extended state and three of the linear actuators 432 are partially or completely retracted, causing portions of the rim 434 and tire 436 to flatten against the ground surface 420. Preferably, the magnitudes of retractions of the three partially or completely retracted linear actuators 432 is effected in a manner that causes the center of gravity point 415 to be directly vertical from the axle 401, resulting in stable standing and parking of the two-wheeled vehicle 400. However, the center of gravity point 415 need not be maintained exactly above the axle 401 to balance the vehicle if a braking torque is also provided on the axle 401. In such a case, small movements of the center of gravity 415, which might be caused by movement of occupants within the vehicle 400, would not require additional power to balance the vehicle.

FIG. 4-2 illustrates the embodiment of the two-wheeled vehicle 400 in a moveable state employing an embodiment of the electro-mechanical wheel assembly 430. As shown, all twelve of the linear actuators 432 are in fully extended states, and the center of gravity point 415 is forward of the vertical line 410 passing through the axle 401, resulting in a moment around the axle 401 that can be used to accelerate the vehicle 400, to counteract the effects of aerodynamic drag on the vehicle, and so on. In one embodiment, forward or reverse motion of the vehicle 400 can be effected by sequentially retracting and subsequently extending the linear actuators 432 due to the moment caused by the movement of the center of gravity point 415 in relation to the vertical line 410 passing through the axle 401. The vehicle 400 can smoothly transition to this moveable state from the stationary state shown in FIG. 4-1 by gradually changing the shape of the rim 434 and tire 436 as it rotates forward and increases speed.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

1. A wheel assembly for a vehicle, comprising:
a hub portion supporting a plurality of controllable variable length spoke elements supporting a conformable rim assembly supporting a tire element;
the hub portion being concentric to an axis of rotation and including a support structure;
the controllable variable length spoke elements each including:
a first end mechanically coupled to the support structure of the hub portion,
a length-varying actuator individually controllable to a selected length, and
a second end coupled to an inner periphery of the conformable rim assembly; and
the conformable annular rim assembly including a plurality of arc sections.

2. The wheel assembly of claim 1, wherein the spoke elements comprise radially-oriented spoke elements.

3. The wheel assembly of claim 1, wherein the spoke elements comprise eccentrically-oriented spoke elements.

4. The wheel assembly of claim 1, wherein the controllable variable length spoke elements are perpendicular to the axis of rotation.

5. The wheel assembly of claim 1, wherein the tire element comprises a unitary pneumatic tire.

6. The wheel assembly of claim 1, wherein the tire element comprises a track.

7. The wheel assembly of claim 1, wherein the plurality of arc sections of the conformable annular rim assembly are flexibly intercoupled.

8. A vehicle propulsion system including a power-split powertrain system, the power-split powertrain system comprising:
an internal combustion engine couplable to a motor/generator mechanically coupled to a torque transmission device mechanically coupled to an axle; and
first and second electro-mechanical wheels coupled to the axle and configured to generate vehicle propulsion without imparting torque to the powertrain system.

9. The vehicle propulsion system of claim 8, wherein the internal combustion engine couplable to a motor/generator mechanically coupled to a torque transmission device mechanically coupled to an axle comprises the motor/generator mechanically coupled to a planetary gear set, said planetary gear set coupled to the first and second electro-mechanical wheels via the axle.

10. The vehicle propulsion system of claim 8, wherein the first and second electro-mechanical wheels configured to generate vehicle propulsion without imparting torque to the powertrain system comprise the first and second electro-mechanical wheels configured to effect wheel eccentricity to generate a moment on the axle to generate vehicle propulsion.

11. The vehicle propulsion system of claim 8, wherein the first and second electro-mechanical wheels configured to generate vehicle propulsion without imparting torque to the powertrain system comprise the first and second electro-mechanical wheels configured to effect wheel eccentricity to generate a moment on the axle to generate vehicle braking.

12. The vehicle propulsion system of claim 8, wherein the first and second electro-mechanical wheels configured to generate vehicle propulsion without imparting torque to the powertrain system further comprise the first and second electro-mechanical wheels configured to effect wheel eccentricity to effect vehicle balancing when the vehicle is in a stopped position.

13. The vehicle propulsion system of claim 8, wherein the first and second electro-mechanical wheels each comprises a wheel assembly including:
a hub portion supporting a plurality of controllable variable length spoke elements supporting a conformable annular rim assembly supporting an annular tire element;
the hub portion being concentric to the axle and including a support structure;
the controllable variable length spoke elements each including:
a first end mechanically coupled to the support structure of the hub portion,
a length-varying actuator individually controllable to a selected length, and
a second end coupled to an inner periphery of the conformable rim assembly; and
the conformable annular rim assembly including a plurality of segmented sections.

14. A method for generating propulsion in a two-wheeled vehicle, said wheels each including a hub portion supporting a plurality of controllable variable-length spoke elements supporting a conformable annular rim assembly, said wheels coupled to an axle defining a common axis of rotation, the method comprising:
arranging a center of gravity of the vehicle forward of the axis of rotation; and
sequentially retracting and extending the variable-length spoke elements to generate a moment about the common axis of rotation.

15. The method of claim 14, wherein sequentially retracting and extending the variable-length spoke elements to generate a moment about the common axis of rotation comprises sequentially retracting and then extending the variable-length spoke elements to generate wheel eccentricity to generate a moment about the common axis of rotation.

16. The method of claim 14, wherein sequentially retracting and then extending the variable-length spoke elements to generate wheel eccentricity to generate a moment about the common axis of rotation comprises sequentially retracting and then extending the variable-length spoke elements to generate wheel eccentricity to effect vehicle propulsion.

17. The method of claim 14, wherein sequentially retracting and then extending the variable-length spoke elements to generate wheel eccentricity to generate a moment about the common axis of rotation comprises sequentially retracting and then extending the variable-length spoke elements to generate wheel eccentricity to effect vehicle braking.

18. The method of claim 14, further comprising retracting selected ones of the variable-length spoke elements to counterbalance a moment about the axis of rotation to effect vehicle balance in a non-moving state.
